(19) United States
(12) Patent Application Publication
(10) Pub. No.: US 2008/0097850 A1
(43) Pub. Date: Apr. 24, 2008

(54) System and Method for Administering Customized Affinity and Rewards Programs

(76) Inventors: David A. Kristal, St. Paul, MN (US); Jenifer J. Cloutier, Woodbury, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/862,795

(22) Filed: Sep. 27, 2007

Related U.S. Application Data
(60) Provisional application No. 60/827,297, filed on Sep. 28, 2006.

(51) Int. Cl. G06Q 30/00

(52) U.S. Cl. 705/14

(57) ABSTRACT

A system and method for administering customized affinity and rewards programs enables businesses to consolidate, deploy and administer a variety of customizable and integrated affinity programs and reward points programs for their customers and/or employees. Using the system, businesses and other entities (“business partners”) may design, implement and manage both rewards and affinity programs for its employees and/or customers (“participants”). Customer service may be provided for access to the system both by each business partner and participant. Reporting, system access, and data analysis is also provided to enable the business partners and third parties, to assess the status of the programs, for example, to assess whether the programs are meeting defined goals and objectives of the business or the fulfillment provider. Data may be obtained from one or more third party sources, for example, through a data ETL process or via web service integration. One or more system administrators may also be provided to perform administrative functions, such as monitoring operation of the system and assessing the quality of service provided by the system to the business partners and their participants as well as to the fulfillment providers. Electronic lead messages may be generated by customer service and automatically provided to the associated business partners.

### CROSS-REFERENCE TO RELATED APPLICATION(S)

This application claims the benefit of provisional U.S. Application No. 60/827,297, filed on Sep. 28, 2006, the contents of which is incorporated by reference herein.

### FIELD OF THE INVENTION

The present invention relates to a computer-implemented system and method for offering, implementing and managing customized reward programs and affinity programs to facilitate relationships and transaction channels for and among participants, business partners, customer service representatives, system administrators and other entities.

### BACKGROUND

Businesses seeking to attract customers and improve customer loyalty may offer rewards programs that offer benefits to frequent customers. For example, a business may provide discounts, special offers or rewards (such as reward points redeemable for merchandise or services) to customers who purchase a certain amount of goods or services or who meet other loyalty criteria as determined by the business.

Businesses may also seek to attract customers and improve customer loyalty by providing affinity programs. For example, a business may offer its customers membership in a club or other organization that enables the customers to obtain discounts or special deals from other merchants, to access products and/or services offered by the business or third parties (“affinity partners”), and/or to access tools and applications that may be beneficial to the customers.

### SUMMARY OF THE INVENTION

The present invention relates to a system and method for consolidating, deploying and administering customized affinity and rewards programs to enable businesses to offer and manage a variety of customized and integrated affinity programs and rewards programs for their customers and/or employees. Using the system, businesses and other entities (“business partners”) may design, implement and manage both reward programs and affinity programs for its employees and/or customers (“participants”). Participants may include both businesses and individuals. Customer service may be provided for access to the system both by each business partner and its participants (employees and/or customers (including businesses and individuals)). Reporting, system access, and data analysis is also provided to enable the business partners and third parties, including affinity service providers and/or reward providers (“fulfillment providers”), to assess the status of the programs, for example, to assess whether the programs are meeting defined goals and objectives of the business or the fulfillment provider. Data may be obtained from one or more third party sources, for example, through a data ETL process or web service integration (e.g., business-to-business real-time data transfer). One or more system administrators may also be provided to perform administrative functions, such as monitoring operation of the system and assessing the quality of service provided by the system to the business partners and their participants as well as to the fulfillment providers. Thus, the system may be implemented to facilitate relationships and transaction channels among business partners, participants, fulfillment providers, customer service, and the system administrator(s).

Rewards programs offered by the system may comprise access to rewards that can be delivered in the form of products or services fulfilled, for example, through a rewards catalog provided by one or more third party rewards providers, and may provide for any type of reward, such as name brand items, services, rebates, checks, cash-back offers, the issuance of gift certificates/cards or any other type of reward. In some instances, reward programs may be implemented by reward points awarded by business partners to their participants.

Affinity programs offered by the system may, for example, enable business partners to provide participants with an assortment of benefits and tools to assist in their operations. For example, an affinity program offered via the system may enable participants to access a network of vendors and/or a suite of proprietary management tools and resources that impart valuable business knowledge. The system may further enable business partners to provide discounted products and services to support the ongoing operations of their customers. The system may deliver these offerings to participants of a plurality of business partners through customized, nationwide programs developed and managed on each business partner's behalf by the system administrator.

The system may further support each customized program, for example, by initiating frequent communication with participants (via a variety of marketing channels) and/or by a customer service center, which may be implemented to provide a single point of contact for all participant service needs via a program-specific 800 number and/or a web portal. The customer service center may be designed to handle and track all inbound and outbound service calls; communication with business partners, participants, fulfillment providers; and/or distribution of marketing materials and other promotional or limited time offer communications.

The system may be implemented to provide program-specific toll free numbers in conjunction with software-based identification codes to enable the system to track the activities, expenditure and savings of participants of each program which may be utilized, for example, to generate periodic reports that highlight the value delivered to each business partner, participant, or fulfillment provider. Additionally, the system may generate reports on membership levels and program activity, for example, sorted by participant (customer or employee), business partner or fulfillment provider, or by communication medium (telephone or web).

An exemplary computer-implemented system for administering affinity and reward points programs may include an administrative module for managing and storing program data associated with a plurality of affinity programs and reward points programs, wherein each affinity program and reward points program is offered by a client to one or more participants, wherein each participant is a customer or employee of the client, and wherein the affinity program or reward points program offered by each client is customizable for the respective client. At least one participant access device enables participant access to program data for each affinity program and reward points program available to the participant, wherein the participant access device obtains and displays program data relating to the available programs from the administrative module and enables the participant to enter data relating to the available programs for transmission to the administrative module. At least one fulfillment provider access device enables fulfillment provider access to program data for selected affinity programs or reward points programs associated with the accessing fulfillment provider, wherein each fulfillment provider provides services, rewards, or other benefits to enable fulfillment of one or more of the associated programs, wherein the fulfillment provider access device obtains and displays program data relating to the associated programs from the administrative module and enables the fulfillment provider to enter data relating to the associated programs for transmission to the administrative module. A customer support terminal communicatively coupled to the administrative module enables a customer service representative to access and manage participant data, program data, and fulfillment provider data in response to a customer service request from a client, participant or fulfillment provider.

An exemplary computer-implemented method for administering affinity and reward points programs may include:

managing and storing program data associated with a plurality of affinity programs and reward points programs, wherein each affinity program and reward points program is offered by a client to one or more participants, wherein each participant is a customer or employee of the client, and wherein the affinity program or reward points program offered by each client is customizable for the respective client;

enabling participant access to program data for each affinity program and reward points program available to the participant, wherein the participant accesses program data relating to the available programs and enters data relating to the available programs;

enabling fulfillment provider access to program data for selected affinity programs or reward points programs associated with the accessing fulfillment provider, wherein each fulfillment provider provides services, rewards, or other benefits to enable fulfillment of one or more of the associated programs, wherein the fulfillment provider accesses program data relating to the associated programs from the administrative module and enters data relating to the associated programs; and

enabling a customer service representative to access and manage participant data, program data, and fulfillment provider data in response to a customer service request from a client, participant or fulfillment provider.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 provides a diagram of an exemplary system for administering customized affinity and rewards programs.

FIG. 2 provides an exemplary diagram of a services management module (ASM) for use in the system illustrated in FIG. 1.

FIG. 3 provides an exemplary data flow overview for the system in FIG. 1.

FIG. 4 provides an exemplary detailed data flow diagram for the system of FIG. 1.

FIG. 5 provides an exemplary block diagram of a system architecture for implementing a system and method for administering business services and rewards programs.

FIG. 6 provides an exemplary block diagram of a core data model for use in the system of FIG. 1.

FIGS. 7-12 provide exemplary illustrations of display screens that may be used in a system for administering business services and rewards programs.

### DETAILED DESCRIPTION

Various embodiments of the present invention will now be described in detail with reference to the accompanying drawings.

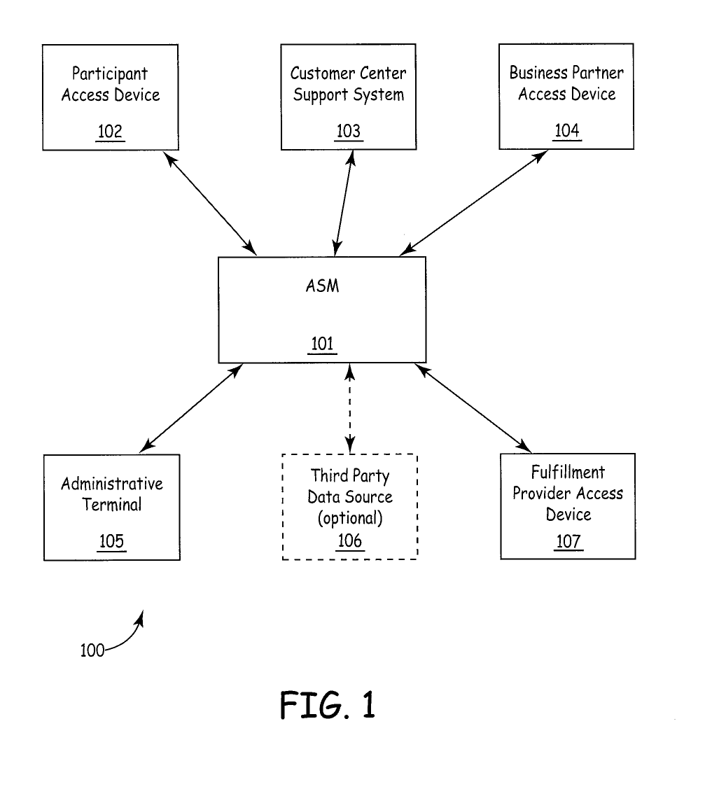

With reference to FIG. 1, an exemplary system 100 for administering customized affinity and rewards programs includes a computer-implemented Administrator Services Management (ASM) module 101. ASM 101 may be configured to provide a plurality of interfaces with businesses, participants, fulfillment providers, other entities (such as third party software applications and data sources), and system administrators. Each interface provided by ASM 101 is customizable to enable implementation of the customized affinity and/or rewards programs desired by the businesses, participants, and/or fulfillment providers.

As shown in FIG. 1, one or more participant access devices 102 and business partner access devices 104, such as computer terminals, wired or wireless access devices, portable communication devices, etc., having Internet or other network access are communicatively coupled to ASM 101. A customer services application, for example, call center support system (CCSS) 103 is also communicatively coupled to ASM 101. An administrative application 105 is provided to enable a system administrator to perform administrative functions. Additionally, ASM 101 optionally may receive and store data from one or more third party data sources 106, for example, via an extract-transform-load (ETL) process. Fulfillment providers may be given access to ASM 101 via one or more access terminals 107.

All components of system 100 may communicate via secure communication channels, which may be implemented using schemes of strong password authentication, strategic encryption, user and permission maintenance, network firewalls, intrusion detection systems, and/or other security measures.

ASM 101 generates a plurality of customizable websites, web portals or other interfaces that may be accessed by the business partners via access devices 104, participants via access devices 102, fulfillment providers via access devices 107, customer service representatives via CCSS 103, and system administrator(s) via administrative module 105.

For example, participants may access a website via a remote computer terminal or other wired or wireless access device 102, such as a portable browser-enabled device. Access to the participant website enables authorized participants to perform a variety of functions relating to affinity and/or rewards programs offered to them by associated business partners. The participant websites enable the participants to enter data, transmit data to ASM 101, and receive and view data transmitted by ASM 101 via access device 102.

In one implementation of system 100, publicly accessible websites maintained by ASM 101 provide participant profile and opt-out functionality to authenticated participants of a customized program for a business partner and its associated participants (including customers, employees, and/or vendors). Participants may be authenticated through password authentication or other secure login protocol. Depending on the selections of the business partner, these sites also may enable authenticated participants access to access one or more of the following functions:
Point redemption through an a product/reward catalog with wishlist, shopping cart, online checkout, and/or account/receipt review
Access details on point-earning rules and special point promotions
Access account balance and details of point-earning transactions
Perform sweepstakes registration
Complete surveys
Access service details and lead generation for third party affinity program providers

ASM 101 also may optionally provide new participant registration functionality via the participant website. A customized registration form may be provided for any business partner who wishes to allow online participant registrations. For example, these registrations may either grant instant access or delayed access, with the possibility of customer service intervention.

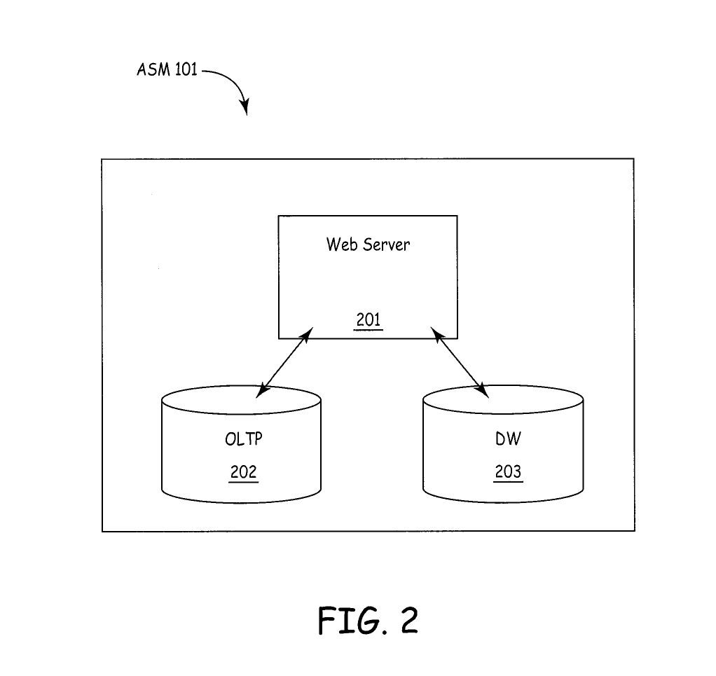

Depending on requirements of the business, the registration process may include analysis of a number of participant data fields to validate eligibility and register unique user names, which may be performed by ASM 101 (for example, processor 202 in FIG. 2, described below). If a duplicate user name match is found, the new registrant may be instructed to check the e-mail address of the master participant for instructions on adding a secondary participant, or alternately to contact customer service for assistance. This process may be implemented to protect against overlapping and/or fraudulent registrations.

Call center support system (CCSS) 103 may be implemented as the primary interface for customer service representatives (CSRs) to interact with ASM 101. Through it, CSRs may be able to search for participants by a number of different criteria, customized by relevance to the business partner program. Once a participant is identified, the CSR may gain access to account details, participant profile data and opt-out status, and can manage participant and CSR names and passwords. New participants can be added through CCSS 103, accounts can be activated, disabled, or closed, and so forth.

By accessing the interfaces provided by CCSS 103, the CSR is presented with all services available to the participant, including service and vendor descriptions, and is given the ability to generate leads on behalf of the participant. In other program implementations, the CSR is provided access to the same account details as the participants and can manually enter receipts from point issuing fulfillment providers.

CCSS 103 also may track all direct interaction with the participants. Faxes and e-mails can be stored, and notes on phone calls may be recorded by the CSRs. Calling campaigns may be managed by a series of user interface screens that allow a CSR manager to define campaign parameters and assign campaign segments to individual CSRs. Combined with website and an interactive voice response (IVR) tracking, all contact events with the participant can be recorded for storage in ASM 101.

All phone calls into the customer call center may be routed through an IVR and automatic call distributor (ACD) system before reaching an individual CSR. For example, the system may be implemented using applications from PrairieFyre® Software and run on Mitel® and Dell® hardware. All e-mails to the call center may be queued, for example, in Microsoft® Exchange through the same software, with extensive follow-up and management tracking integrated with Exchange/Outlook. Incoming faxes may be processed, for example, by GFI® FaxMaker to produce .PDF e-mails that go directly into the call center queue.

In one implementation of the system, once a participant has been identified by phone number, automatically or entered by hand if unrecognized, the IVR dynamically interacts with participants by providing functionality related to their program membership status. The source and destination phone numbers as well as the path taken through the IVR are recorded for each phone call, for example, to enable analysis of this data to assess customer service usage and effectiveness.

When a contact event has reached a CSR, the CSR accesses CCSS 103 to learn more information about the participant. If so configured, the ACD module can trigger the CSR's computer to open the CSR's web browser directly to the customer's data screen, for example, via a screen pop.

Additionally, customer service administrators also may manage non-participant data through a CCSS administration software application. This application may be used to manage external data of clients, including services offered, contact information and individual personnel. This application also may provide detailed information for affinity programs and product catalog, for managing clients' access to applications and reports, and for administering the content in both the public and client-specific websites. Metadata on marketing campaigns, including segmentation details and collateral, may be entered into the CCSS administration software application, as may be details and rules for point-earning promotions.

Business partner access terminals 104 may enable business partners to access ASM 101, for example, via a website, web portal or other user interface. Information such as reports and other data may be made available to business partners through a secure interface displayed by terminal 104. The interface also may provide an interface to enable the business partner to enter data. Business partner data may be supplied by terminal(s) 104 to ASM 101, for example, by batch files or any other data transmission method. In some instances, fulfillment and inventory data may be managed manually by the business partner through the interface.

Business partner terminals 104 may further provide access to secure dashboard reports that summarize key performance indicators across areas of each affinity and or rewards program offered to their associated participants. Reports may be developed, for example, with Microsoft® SQL Server 2005 Reporting Services and can be viewed or saved in a variety of formats, including HTML, Excel, .PDF, .CSV, and XML. These reports also may be made available by subscription.

In one implementation of the system, a Microsoft® SQL Server 2005 Report Server may be implemented to provide reports for monitoring program performance. Internal users (such as administrators) may gain direct access to the reporting services interface. For heightened security, reporting portals and dashboards for external users (such as business partners and fulfillment providers) may acquire report access through a web services API built into the reporting server.

Reporting services further may provide subscription capabilities so that any given report can be scheduled to run and be e-mailed to a user on a periodic basis (e.g., daily, weekly, or monthly). All reports, including scheduled reports, may be distributed in a variety of file types, including Adobe .PDF (Acrobat), HTML for viewing in web browsers, XML data, or spreadsheets in Excel and comma-separated formats.

Data trends and marketing segmentation may be explored through cubes generated from a data warehouse, for example, by SQL Server 2005 Analysis Services. These cubes may be analyzed in commercial products, including Microsoft Excel and ProClarity.

A system administrator may access ASM 101 via one more administrative modules 105, which may be implemented, for example, as a computer terminal networked to the ASM 101. Administrative module 105 may be directly or internally coupled to ASM 101 such that there are no network communication related security issues associated with the link. Alternatively, administrative module 105 may be communicatively coupled to ASM 101 via remote access via a secure network or other network having desired security functionality. Administrative module 105 enables an administrator to perform all desired administrative functions needed to administer system 100. Administrative functions may include, for example, adding users, administering user names and user name groups, online approval of eligible participants, and setting up promotions (defining promotions, applicable dates, etc.).

ASM 101 optionally may receive and store data from one or more third party data sources 106, for example, via an extract-transform-load (ETL) process and/or web service integration. ETL data may be, for example, received as batch files that are provided periodically by the third party data sources 106. Web service integration, such as business-to-business data transfer, may be implemented to enable real-time data transfer between ASM 101 and the third party data sources 106. Data supplied to and from service partners, point issuing partners, and/or other fulfillment providers via terminal(s) 107 and other external data vendors via third party data source(s) 106 may be handled through direct data transfers (e.g., web service integration) and ETL processes. Encrypted fixed-width and XML text files transmitted over secure FTP may be used to supply the bulk of the data, and web services also may be available for streaming data into ASM 101.

In one implementation of system 100, periodic calculation processes, such as awarding of points and subsequent account balance updates, may depend on the data from third parties obtained from third party data source(s) 106. ASM 101 may receive and process the data from the third party source(s) 106 on a periodic basis. For instance, a single job may process a batch file of point-earning purchases by referencing appropriate base rules for the given vendor's products (stored in ASM 101), cross-referencing any current promotions, calculating the number of points to award for the purchase, storing those points on a line-item basis, and finally adding the total number of points awarded to the appropriate participant's account balance.

In one implementation of the system, Microsoft's ETL tool, SQL Server 2005 Integration Services, may be used to check the status of text file transfers, manipulate their contents as needed, and distribute the data enclosed to the proper tables stored in ASM 101, wherein the data may be analyzed, for example, to generate reports for business partners as discussed above with reference to business partner access device(s) 104.

One or more fulfillment provider access terminals 107 may be provided in system 100 to enable fulfillment provider access to ASM 101 to enable the providers to provide rewards and affinity partner links and information. Such access may be implemented to provide access to various information and functionality provided by ASM 101, subject to limitations and restrictions as desired by the implementers of system 100.

With reference to FIG. 2, an exemplary implementation of ASM 101 includes one or more web servers 201 coupled to one or more databases, such an online transaction processing (OLTP) database 202 and a data warehouse 203 (such as an online analytical processing (OLAP) or other data warehouse). OLTP 202 may be implemented as a transactional readable/writable database that ASM 101 accesses for day-to-day operations of the system. Information stored in the database may be accessed and changed by authorized users. Data warehouse 203 may be implemented as a read-only database that is utilized to store both current and historical data that may be used for generating reports and other data analysis. Data stored in data warehouse 203 may be denormalized to enable ease of access by various users.

As described above, in one implementation of the system, Microsoft's ETL tool, SQL Server 2005 Integration Services, may be used to check the status of text file transfers, manipulate their contents as needed, and distribute the data enclosed to the proper tables stored in OLTP database 202 within ASM 101. Integration and Replication Services are used to keep clustered databases synchronized and populating data warehouses and data marts 203.

ASM 101 enables integration of affinity and point-based loyalty programs into a single coherent system, managed through a combination of software applications and integrated third party solutions. ASM 101 may provide a plurality of front-end interfaces customized for different users, such as participants (via participant websites), CSRs (via CCSS 103), system administrators via administrative module 105, and business partners and affinity and/or rewards program fulfillment providers, for example, via reporting portals/dashboards displayed on terminals 104 and 107 respectively.

ASM 101 may be implemented, for example, on a Microsoft platform, leveraging the Net Framework v1.1 for web application development and SQL Server 2005 for relational database management, reporting, multi-dimensional analysis, and ETL.

In addition, ASM 101 facilitates interactions with business partners, participants, and fulfillment providers through phone, fax, and e-mailing queuing and routing; direct data transfer and integration; and/or reporting and analysis services

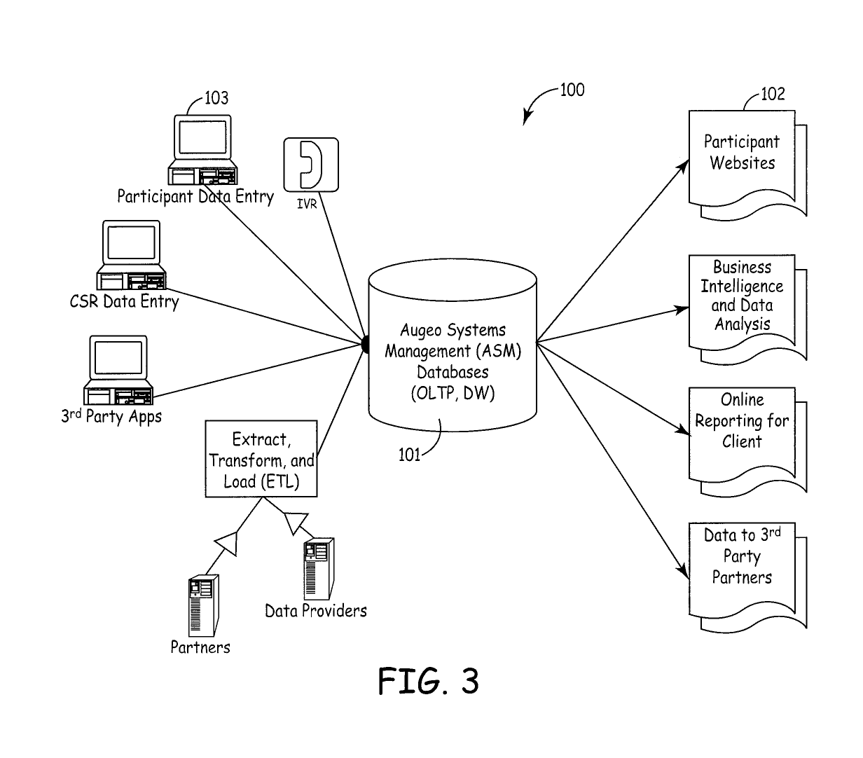

With reference to FIG. 3, participants in the programs may directly interface with system 100 by two means: over the phone and through the Internet. When calling in to the Customer Service line, participants are initially routed through an ACD/IVR system. This system captures the participant's phone number, presents the caller with a menu of options, and places them in an appropriate queue. Statistics on the phone call are automatically stored in transactional database (OLTP) 202. CSR's utilize CCSS 103 to display and record details of the participants' request —such as changing contact information, marking new affinity program leads, or informing the participant of their current point balance. The participant may also use the CCSS 103, for instance, to issue discretionary points. All data displayed and record therein is delivered by the web/application server to the OLTP database 202 in ASM 101.

Participants interacting the through the Web sites via participant access devices 102 may be provided with a broad array of options to fit the needs of a selected program. Participants can alter contact information and change passwords. They may also be able to generate new affinity leads, check point balances, redeem points, or even make purchases from point issuing clients' product catalogues. All data comes from or is directly stored in the OLTP database 202 used by the phone system and call center software.

Once collected in the transactional database, participant information is used primarily in two ways: to instruct the various clients on actions to be taken with respect to the participant, and to monitor and report on the programs' success metrics. Client instructions may include a report of new affinity leads, point redemption orders to fulfill, and so forth. These are delivered by any of three mechanisms: FTP, web services, or through the client interface web site. The clients are then required to report regularly on the status of their interactions with the participants, using the same three methods for transmitting that data to the OLTP database 202.

OLTP 202 data is copied to data warehouse 203. This analytics database provides a single data source combining multiple program databases into a format optimized for reporting. Reports and executive dashboards are delivered to the administrator via terminal 105 and business partners via terminals 104 by accessing a web-based reporting portal.

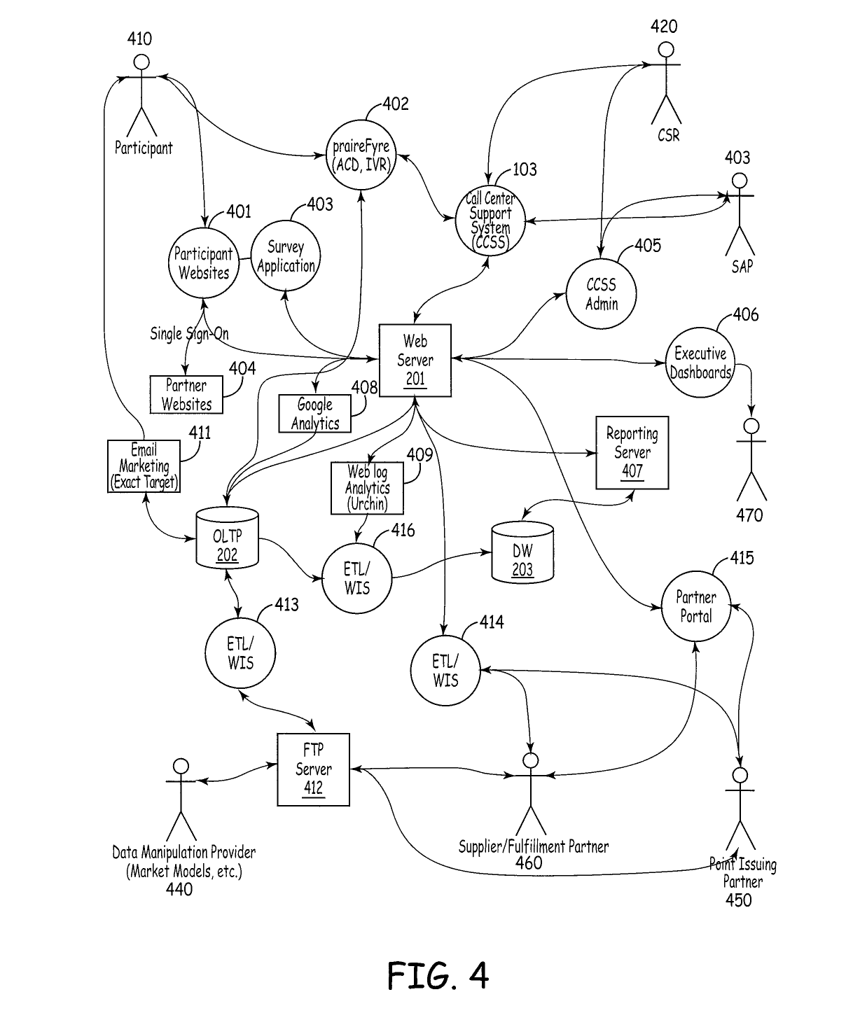

FIG. 4 provides a detailed data flow diagram for system 100. In FIG. 4, there are a number of individuals, each of whom are able to access the system 100: a participant 410, a customer service representative (CSR) 420, a system administrator 430, a third party provider 440, a reward points issuing partner 450, a supplier/fulfillment partner 460, and a system manager 470. The components of ASM 101, which are distributed in the FIG. 4 diagram, include web server 201, OLTP 202 and data warehouse 203.

Participant 410 accesses the system 100 via a participant website software application (“application”) 401 or via voice system application 402, such as an ACD/IVR system, which enables access to Call Center Support System (CCSS) 103. After the participant 410 has signed on to the system (satisfying security measures required for secure access) using participant access device 102 (see FIG. 1), the participant website application 401 enables the participant 410 to access a survey application 403, and access partner websites 404, for example, without needing to sign on for a second time, and access web server 201. Web server 201 generates the user interfaces displayed on the participant's access device 102 and enables the participant 410 to access his/her account and access and perform the functions described above with reference to access device 102 in FIG. 1. Participant access via participant website application 401 may, for example, provide the participant 410 with access to certain data stored in OLTP 202, for example, to sign up for reward points and/or affinity programs and to redeem awards.

Participants 410 may also receive targeted email messages and other types of marketing information from e-mail marketing application 411. This application 411 obtains marketing information and email address data from OLTP 202 and generates targeted e-mail messages to participants, for example, based upon the participant's programs, rewards points and/or affinity program selections or products or programs in which the participant has indicated interest. Data associated with the targeted e-mail messages is communicated to the OLTP 202 for storage and may be transmitted to data warehouse (DW) 203 for analysis.

The CSR 420 may access CCSS 103 (see FIG. 1) as well as a CCSS administrative application 405 that enables the CSR 420 to perform administrative tasks associated with CCSS 103. Data gathered by the CCSS 103 and the CCSS administrative application 405 is communicated to web server 201 and stored in OLTP 202 and/or DW 203. CCSS 103 and CCSS administrative application 405 also enable the CSR 420 to access data needed to perform customer service and related administrative functions. Data may be transmitted between OLTP 202 and DW 203, for example, using ETL and/or web service integration 416.

System administrator 430 may also or alternatively perform system and CCSS administrative functions by accessing CCSS 103 and/or CCSS administrative application 405. The system administrator 430 may also access executive dashboards application 406, thereby gaining access to analytical data concerning, for example, the operation of the system 100, CCSS 103, participant interaction with the system 100, and other desired aspects of the system 100.

A system manager 470 may also access executive dashboard application 406 to gain access to desired information about the system 100. This access enables the manager to monitor the operation of the system, the behavior of the participants 410 using the system 100, etc.

The executive dashboard application 406 may receive analytical data and reports from data warehouse 203, OLTP 202, and reporting server 407. Additional analytics of data obtained and stored within system 100 may be received from one or more third party analytics applications 408, such as performed by Google® Analytics software (which provides “hit rate” statistics concerning the number of users that access or “hit” various web pages or sites generated by the system, such as promotional sites), and/or one or more web log analytics applications 409, such as implemented using web log analytics software from Urchin® (which providers trend data concerning activities or options selected by users who access specific web sites generated by the system), that monitor data downloads from OLTP 202 to data warehouse 203 by ETL or web service integration 410.

Third party data providers 440 may access a File Transfer Protocol (FTP) server 412 to enable data to be transmitted to OLTP 202, for example by ETL or web service integration 413. requests for data, receipt acknowledgement, and other data may also be transmitted to the third party data provider 440 by OLTP 202.

Reward point issuing partners 450 and supplier/fulfillment partners 460 may provide data to the system 100 by transmitting data to web server 201 for storage in OLTP 202 and/or data warehouse 203. Such data may be transmitted to web server 201, for example, using ETL and/or web service integration 414.

Additionally business partners (not shown) and fulfillment providers 450 and 460 may access the system 100 via a partner portal 415, which may be displayed on business partner access devices 104 and 107 (see FIG. 1). The partner portals enable business partners and fulfillment providers 450 and 460 to access data and reports and perform various functionality as described above with reference to access devices 104 and 107 in FIG. 1.

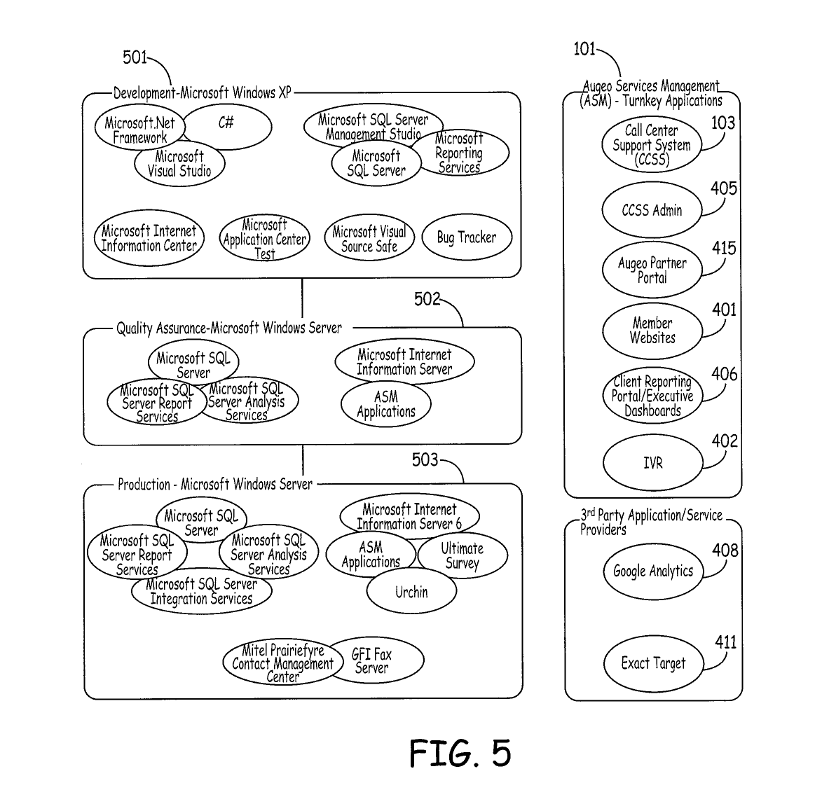

FIG. 5 provides a diagram of an exemplary architecture for system 100. An exemplary core services platform may be implemented using a Microsoft® Windows® XP operating system that runs the software programs included in 501. The XP platform leverages a .Net framework for web application development and Microsoft® SQL Server for relational database management, reporting, multi-dimensional analysis, and ETL functionality.

Microsoft® Windows® Server may be implemented as a platform for quality assurance functionality performed by the software indicated in 502, and may also be used as the platform for production functionality provided by the applications indicated in 503.

ASM 101 turnkey applications include CCSS 103, CCSS administrative application 405, partner portal 415, participant websites 401, executive dashboards 406, and IVR 402 (see FIG. 4).

Third party applications and service providers include data analytics 408, such as provided by Google® Analytics software, and e-mail marketing software application 411.

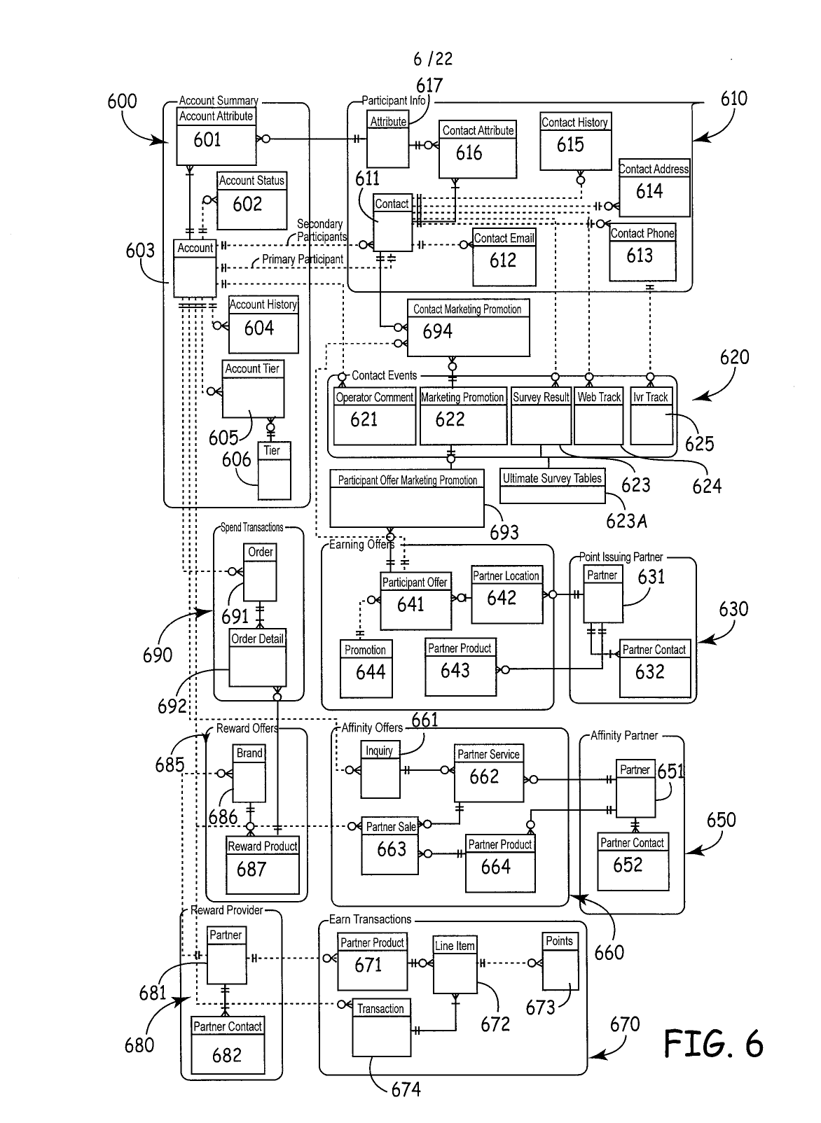

With reference to FIG. 6, an exemplary core data model for system 100 provides a single platform containing all database structures required to manage the administrator's point and affinity marketing programs. These storage structures fall into several broad categories:
Account Summary: This provides the central repository for information, demographics, and program status at the level of a business or household (“an account”). An account summary group 600 may include, for example, data relating to account attributes 601, account status 602, account 603, account history 604, account tier 605, and tier 606.
Participant Info: These tables contain data directly related to the individual people belonging to a household or working for a business. A participant information group 610 may include, for example, data relating to participant contact names 611, contact email addresses 612, contact phone numbers 613, contact addresses 614, contact histories 615, contact attributes 616, and attributes 617.
Contact Events: This contains records of all touchpoints through the CCSS, Web sites, phone system, and marketing campaigns for each account. A contact events group 620 may include, for example, data relating to operator comment 621, marketing promotion 622, survey result 623 (associated with ultimate survey tables 623A), web track 624, and IVR track 625.
Partner: Partner and PartnerContact are displayed in the distinct areas of point issuing partners, reward providers, and affinity partners, though the same storage structures may be used across all three. A data group 630 relating to point issuing partners may include, for example, each partner's name 631 and contact information 632. Data group 630 may be linked to data on earning offers 640 (discussed below). Similarly, a data group 650 relating to affinity partners may include, for example, each partner's name 651 and contact information 652. Data group 650 may be linked to data on affinity offers 660 (discussed below). Likewise, a data group 680 associated with a reward provider may include, for example, each partner's name 681 and contact information 682, and be linked to reward offer data 685 (including product brands 686 and reward products 687) and earn transactions data 670 (including partner products 671, line items 672, points 673, and transactions 674).
Earning Offers 640: These tables describe the special point-earning offers marketed to the participants as well as the point calculation rules.
Earn Transactions 670: Line item detail on the point-earning purchases is recorded here for calculating and tracking account balances.
Reward Offers 685: This includes description data for products that can be purchased by participants using earned points.

Spend Transactions 690 (including orders 691 and order details 692: This includes line item detail on the rewards purchased by participants.

Affinity Offers 660: This data provides details on the services offered through affinity programs, leads generated for these services, and the participants' use of these services.

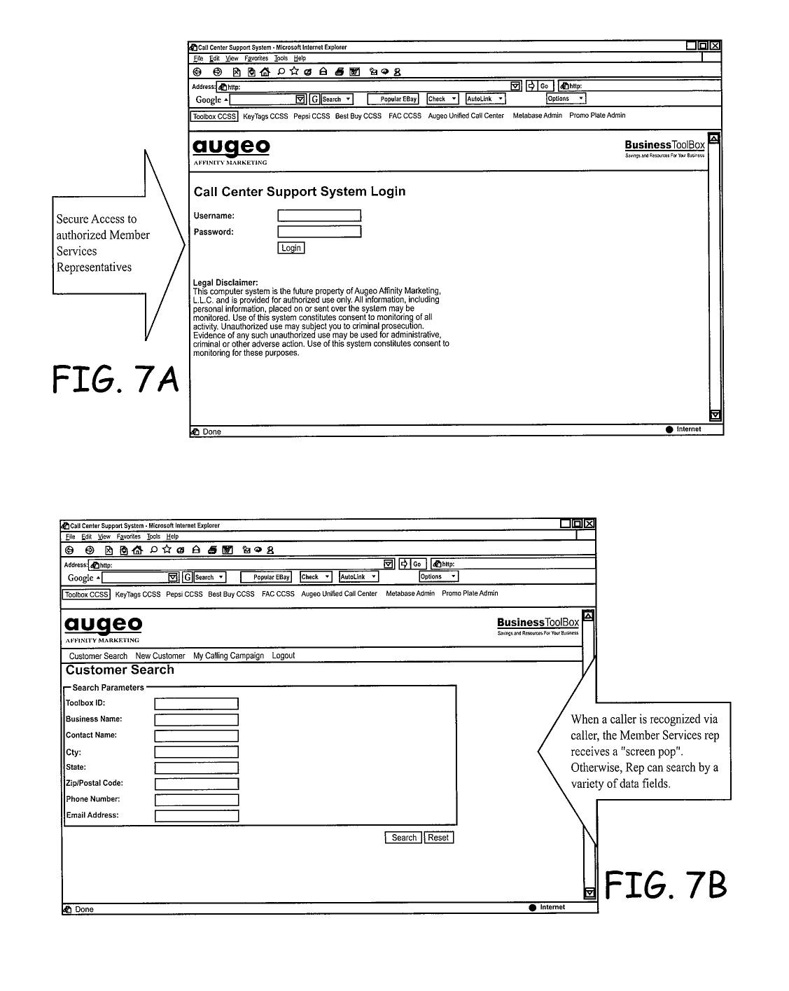

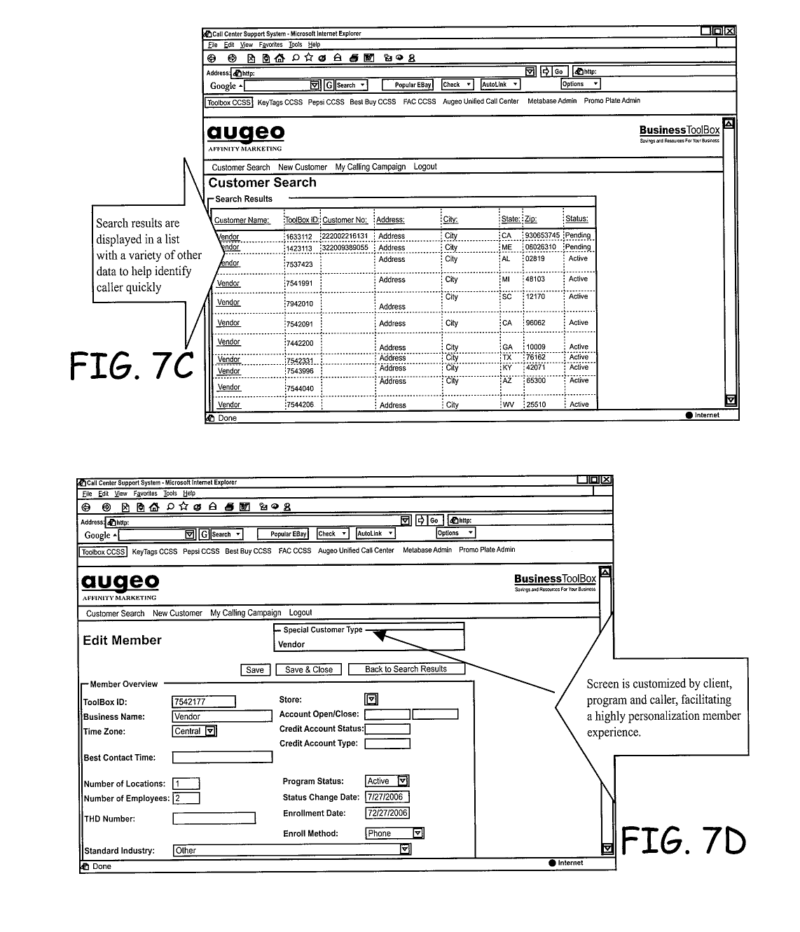

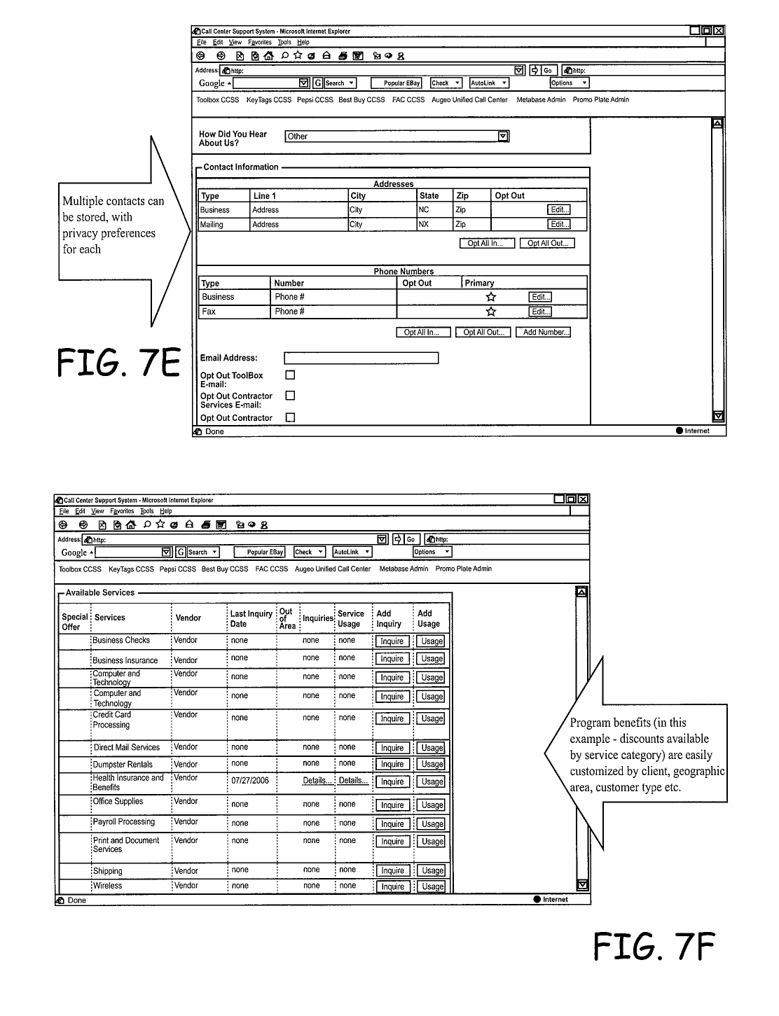

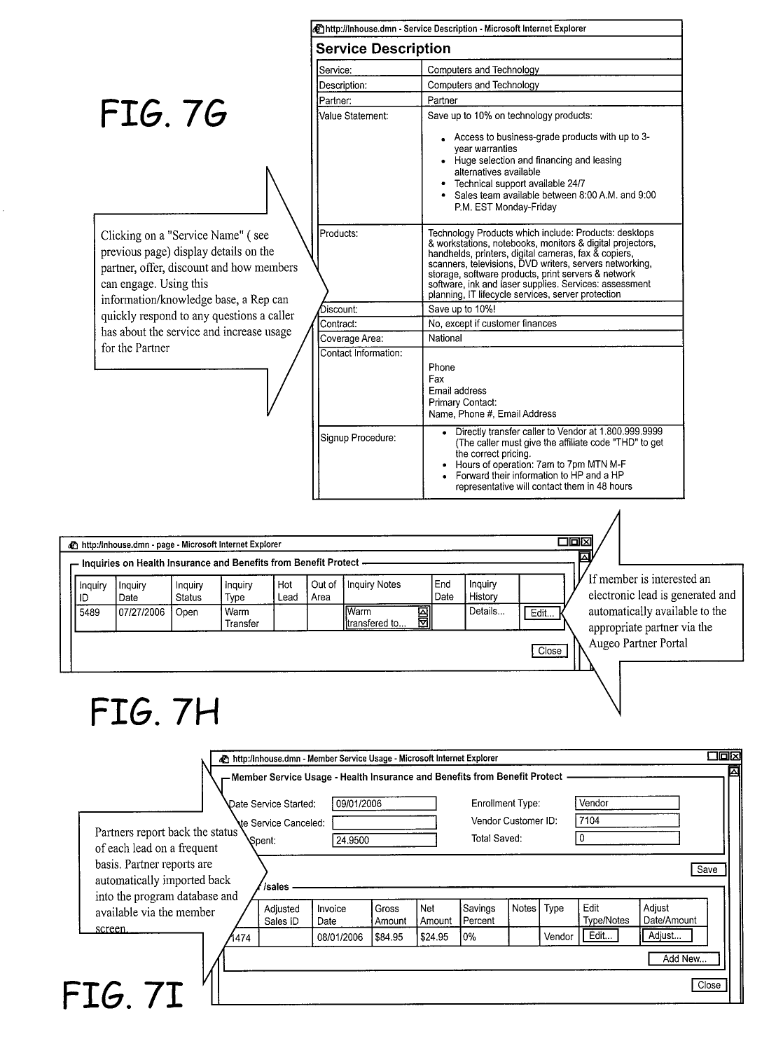

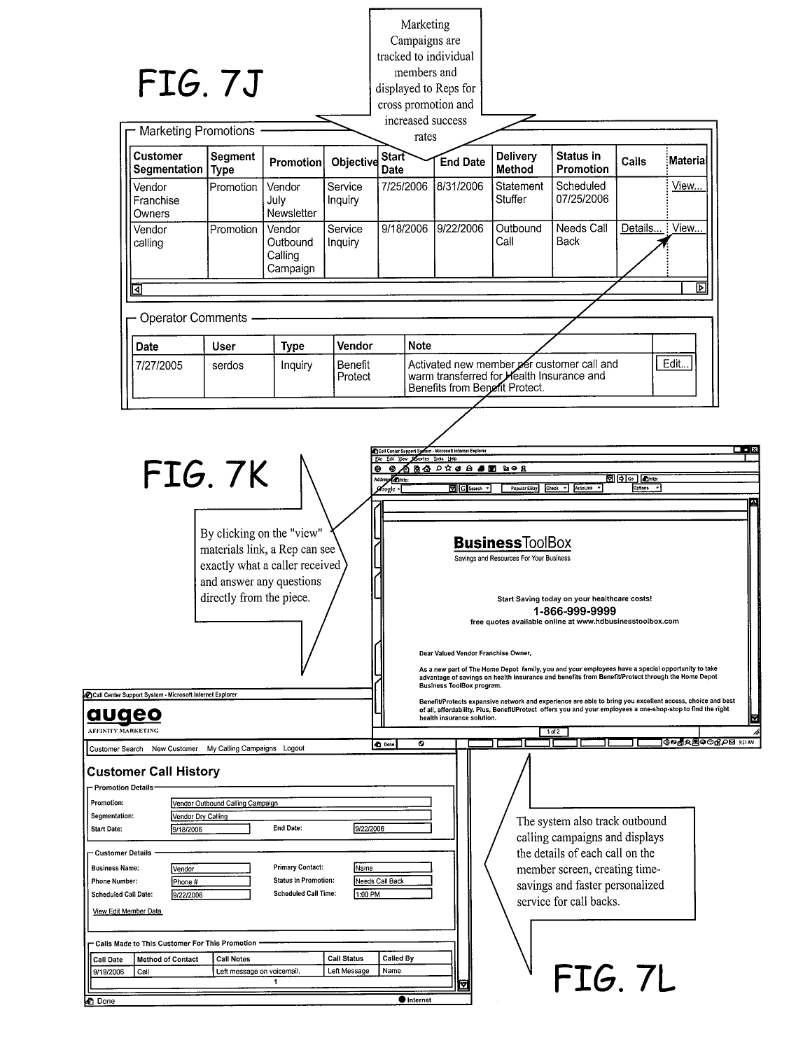

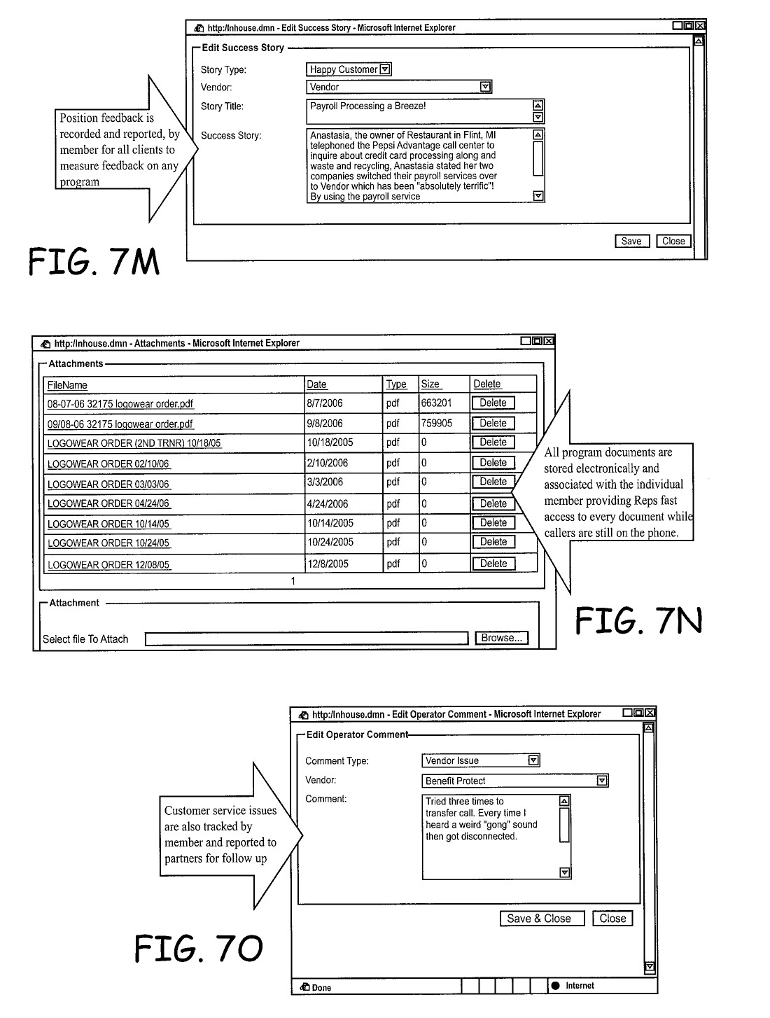

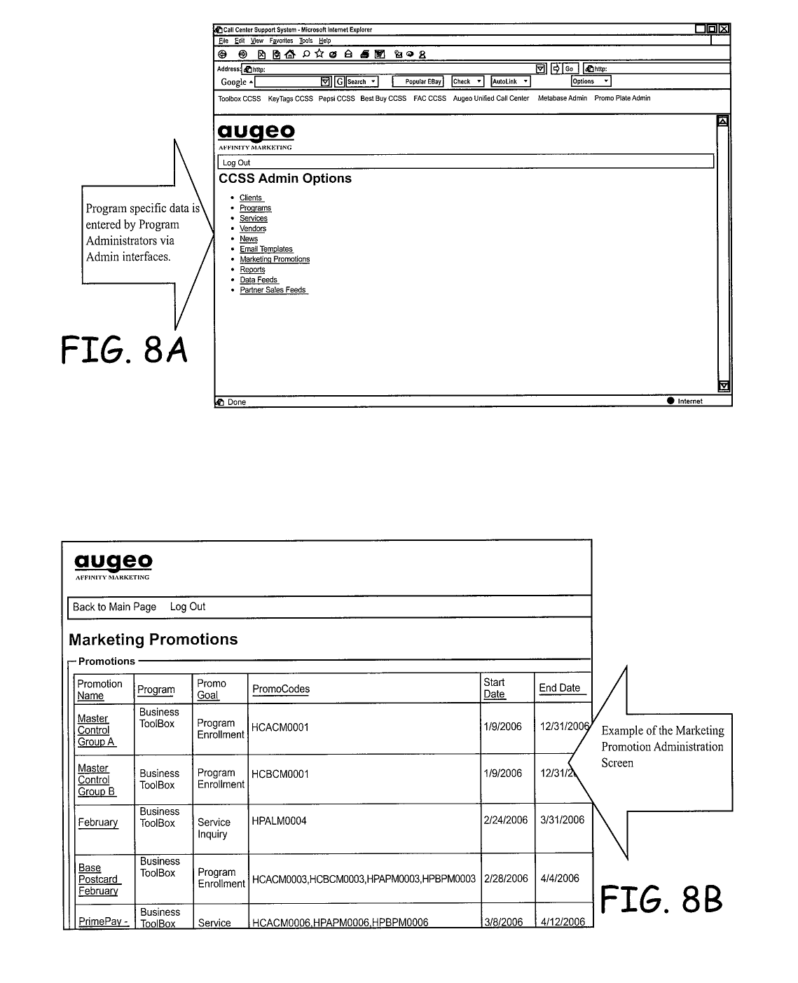

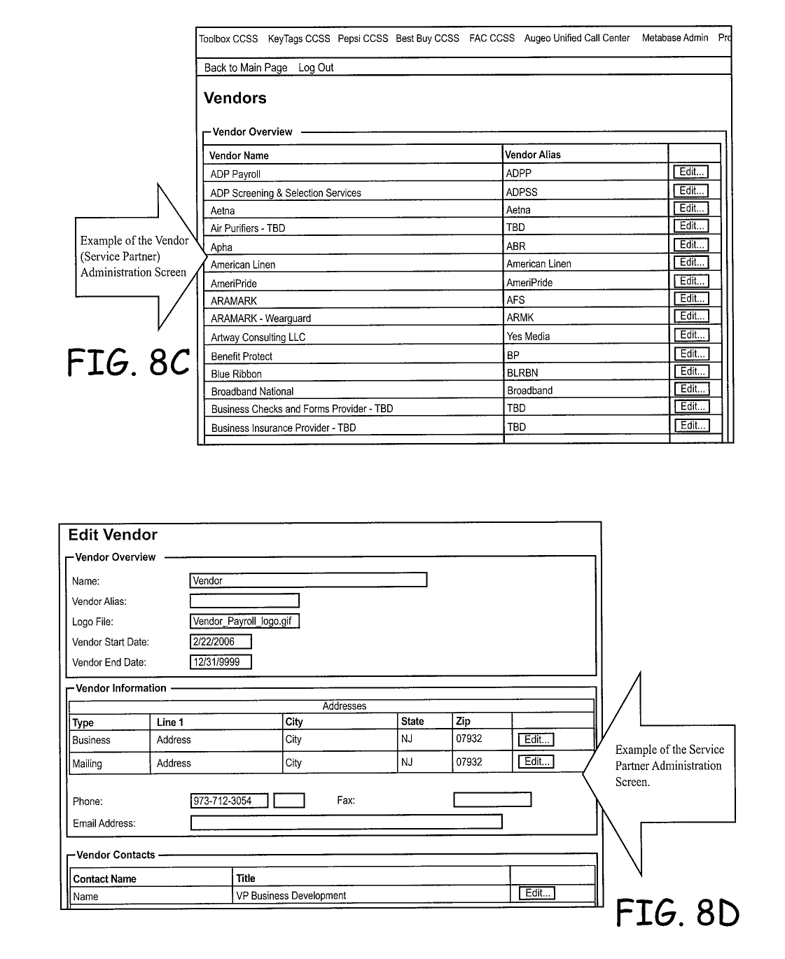

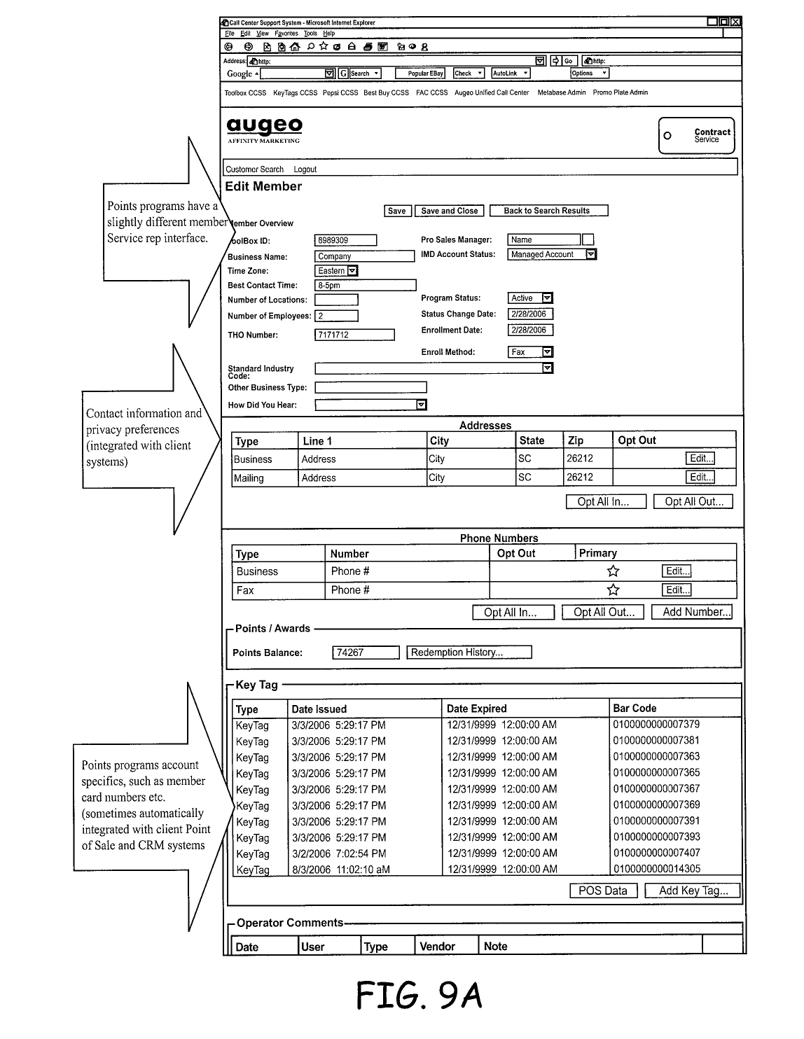

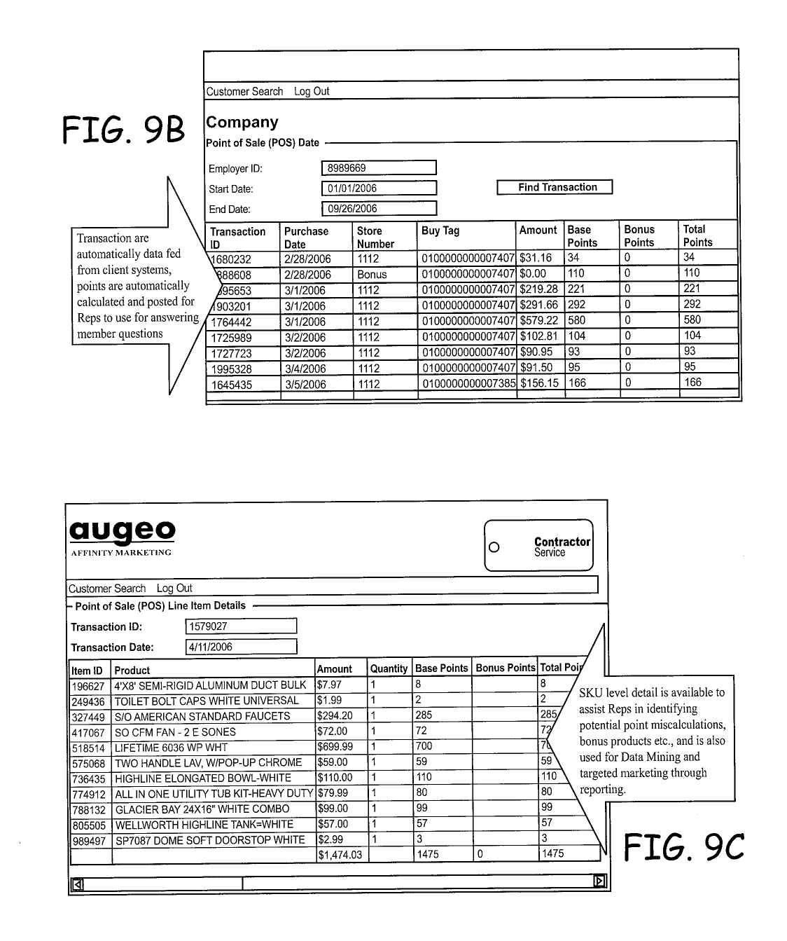

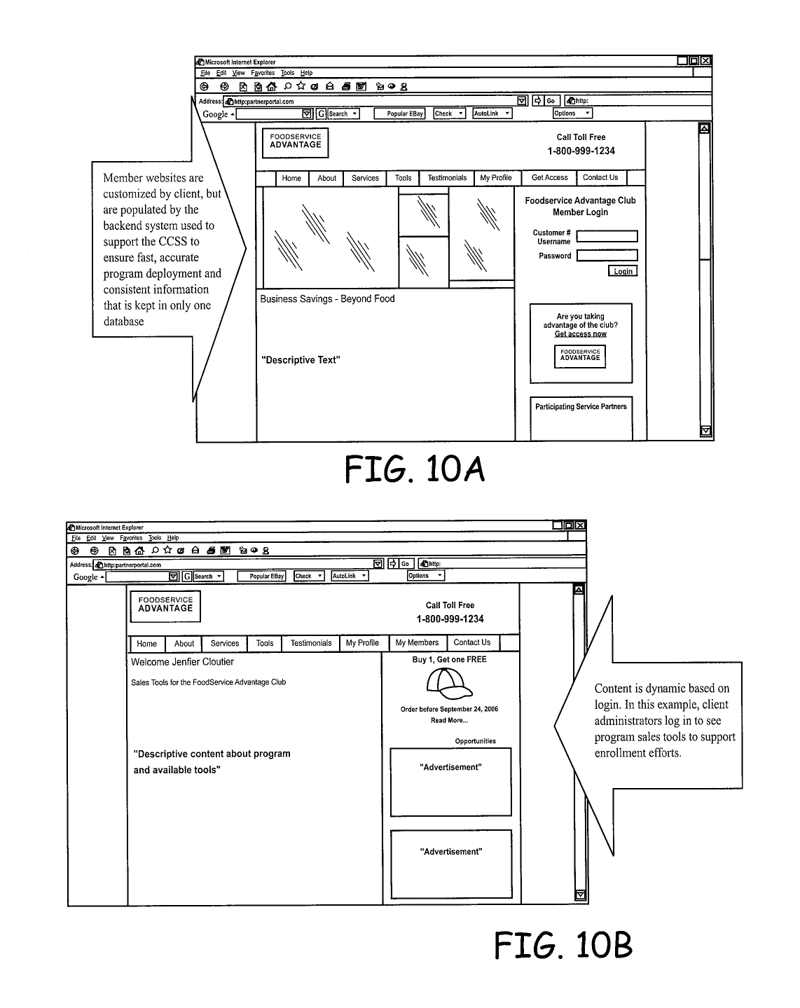

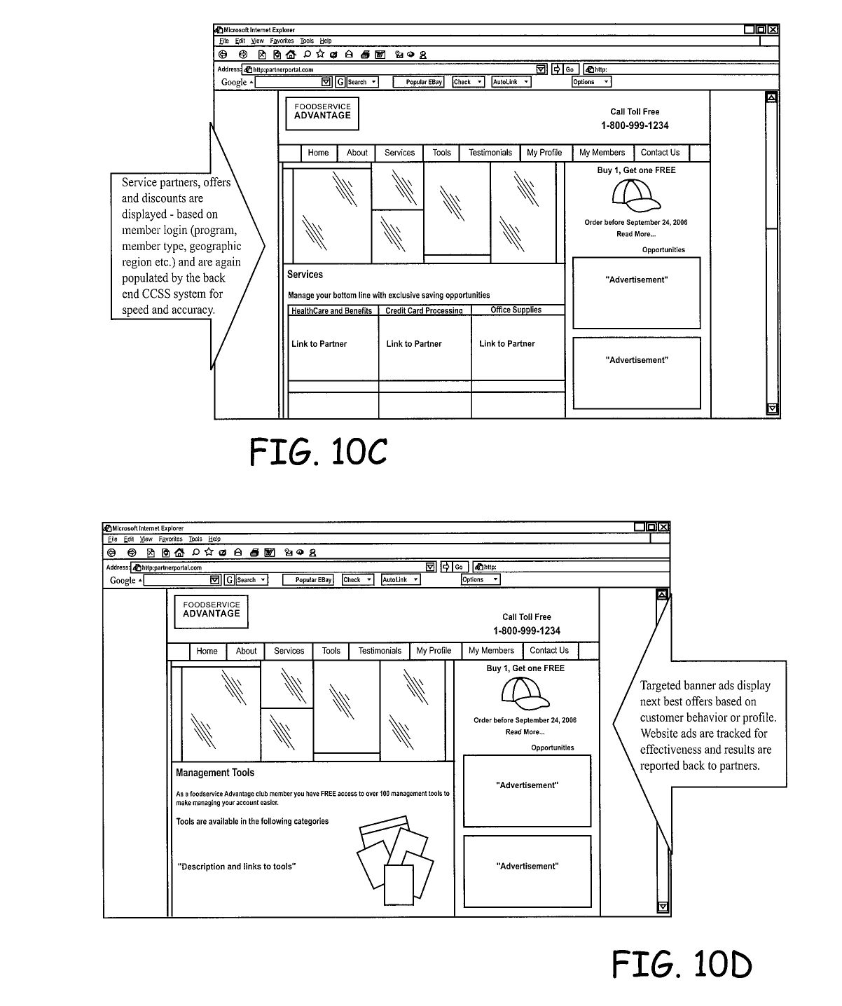

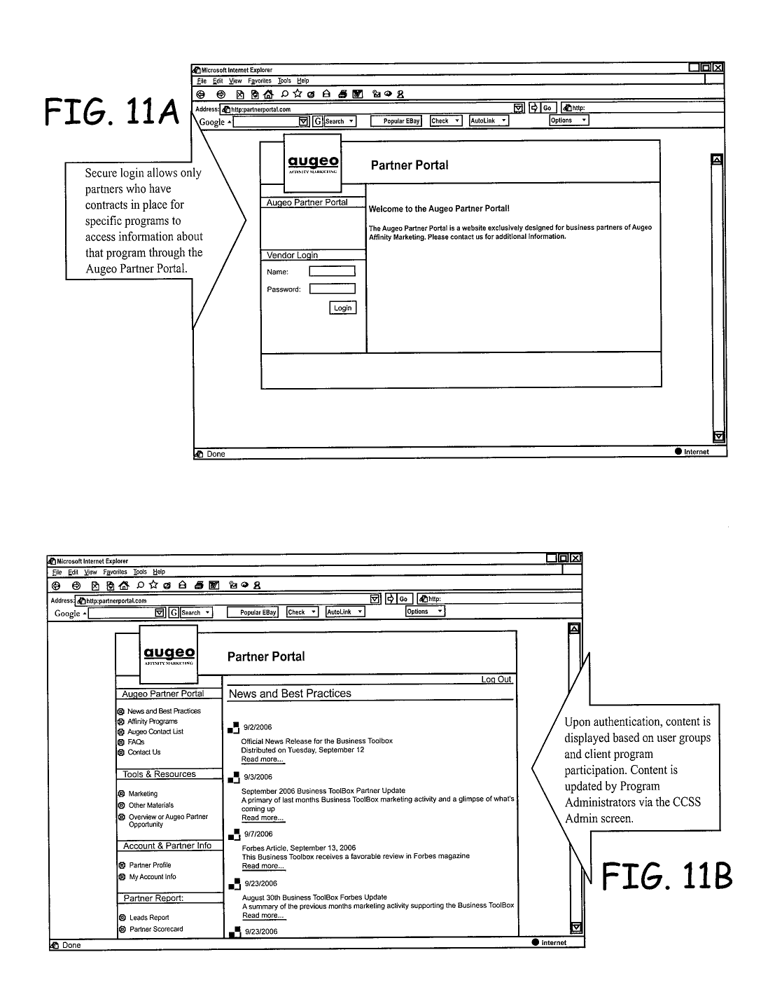

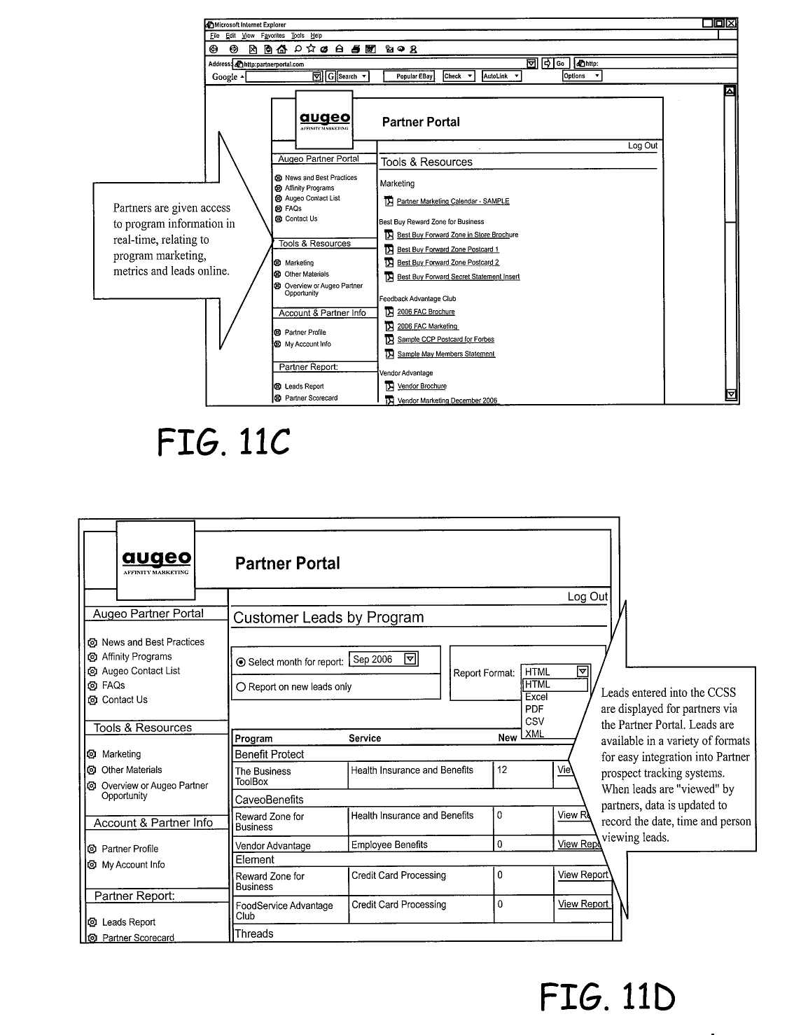

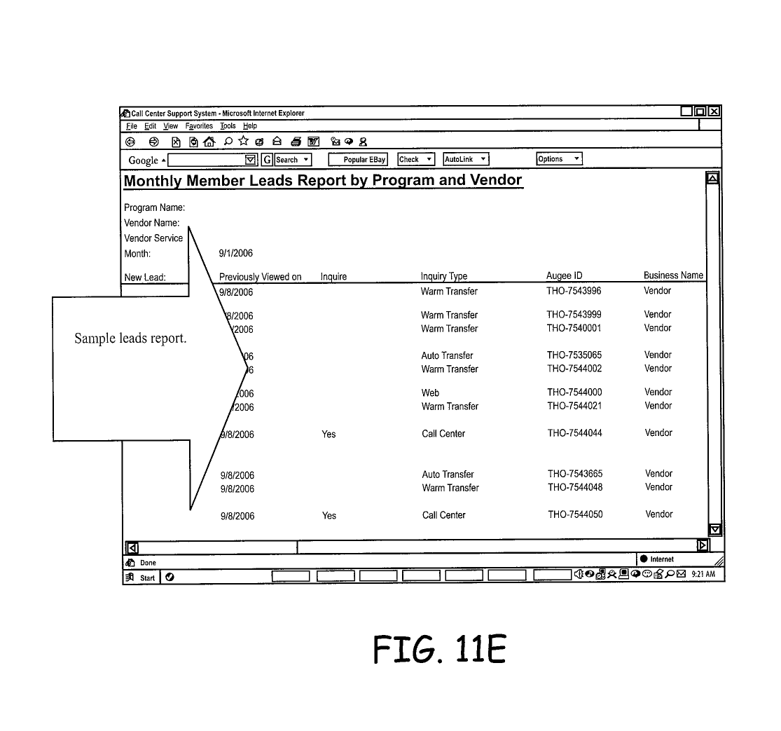

FIGS. 7-12 provide exemplary graphic user interfaces for access by customer service representatives, system administrators, participants, and business partners. FIGS. 7A-7O provide exemplary graphic user interfaces generated by the CCSS 103 for affinity and service programs. FIGS. 8A-8D provide exemplary graphic user interfaces generated by the CCSS administrative application 405 for display on administrative module 105. FIGS. 9A-9C provide exemplary graphic user interfaces generated by the CCSS 103 for reward points programs. FIGS. 10A-10D provide exemplary user interfaces generated by participant website application 401 for display to participants on participant access devices 102. FIGS. 11A-11E provide exemplary user interfaces for generated by the partner portal application 415 for display on business partner access devices 104.

Different customized user interfaces, other than those depicted herein, may be generated for various businesses to address the specific needs of their customers and employees. ASM 101 may generate (and store) data to enable multiple authorized business partners, participants and CSRs to access multiple programs, each customized for the specific business and its participants, and to access affinity programs and/or reward points programs as enabled by the program selected by a particular business for its respective participants.

In the following drawings, participants may be referred to as “members” and customer service representatives may be referred to as “member services representatives.”

With reference to FIGS. 7A-7O, an exemplary series of graphic user interfaces are provided for use by a customer service representative (CSR) who is assisting participants who are members of a “Business ToolBox” program, which is a customized program designed for a specific business partner and its customers, employees, etc. (“participants” or “members”). These user interfaces may be generated and displayed by CCSS 103 using information obtained from ASM 101 (including data from OLTP 202 and data warehouse 203 provided by web server 201).

FIG. 7A depicts an exemplary CCSS 103 login screen that provides secure access to authorized CSRs (also referred to as member services representatives).

FIG. 7B depicts an exemplary interface that enables a CSR to perform a customer (participant) search. When a caller is recognized, for example, using data from the ACD/IVR software application 402, the CSR receives a screen pop identifying the customer. Otherwise, the screen in FIG. 7B may be used to search for customers by a variety of data fields, including toolbox ID, business name, contact name, city, state, zip/postal code, phone number, and/or e-mail address.

FIG. 7C depicts an exemplary display of the results of a customer search input using the display of FIG. 7B. The search results may be, for example, displayed in a list with a variety of other data to assist the CSR to identify the caller. Displayed customer (participant) data may include, for example, customer name, toolbox number, customer number, address, and customer membership status (e.g., pending, active, expired).

FIG. 7D depicts an exemplary display enabling the CSR to edit participant information. The display may be customized by business partner, program (e.g., Business ToolBox or other customized program), and caller (participant).

FIG. 7E depicts an exemplary display of contact information for a participant, which may include multiple contacts for a participant, each associated with a privacy preference (for example, whether to receive targeted marketing e-mail) indicated by the participant.

FIG. 7F depicts an exemplary display of benefits that are available to a selected participant of a customized program. In FIG. 7F, the display lists discounts that are available to the participant by service category. The program benefits may be customized, for example, by business, geographic area, participant type (e.g., customer, preferred customer, employee), or as otherwise desired.

FIG. 7G depicts an exemplary display of a service selected from the list of FIG. 7F. This display provides a service description, including, for example, a general description of the type of service (here “Computers and Technology”), the fulfillment provider providing the service, a value statement indicating the discount or other value available to the participant, the relevant products to which the discount applies, the discount percentage, whether a contract is required, the geographical coverage area, the fulfillment provider contact information, and the sign-up or other procedure that the participant must follow to obtain the discount or other service. The service description may be customized based upon the type of service offering. Product offerings may also be displayed in a similar manner.

FIG. 7H depicts a pop-up screen that is generated when a CSR indicates a participant's interest in a selected service. This screen indicates that an electronic lead has been generated. The electronic lead is immediately accessible by the fulfillment provider offering the service about which the participant has expressed interest. The fulfillment provider may access the electronic lead via partner portal 415 using fulfillment provider access device 104. The electronic lead enables the fulfillment provider to initiate contact with the participant about the selected service.

FIG. 7I depicts an exemplary display screen that displays the status of the fulfillment provider's follow-up on the electronic lead of FIG. 7H. Fulfillment providers may report back concerning the status of each lead on a frequent (e.g., periodic) basis. Fulfillment provider reports may be automatically imported into ASM 101 and made available to CSRs as well as the respective participants via participant website 401.

FIG. 7J depicts an exemplary display of marketing promotions that may be tracked to individual participants and displayed to CSRs for marketing purposes (for example, to promote cross-promotion efforts and increase promotion success rates). This display may include the customer (participant) segment to which the promotion is offered, the segment type, the source or method of communicating the promotion offer, the promotion objective, the promotion start and end dates, the delivery method, the promotion status, call and materials relating to the promotion. Operator comments may also be displayed, which describe CSR contacts with the participant.

FIG. 7K depicts an exemplary display of the promotion materials sent to the participant to enable the CSR to see exactly what promotion information was received by the participant. This display may be accessed by clicking a link provided in the “Materials” column of the display of FIG. 7J.

FIG. 7L depicts an exemplary display of a customer (participant) call history relating, for example, to a selected promotion such as the promotions displayed in FIG. 7J.

FIG. 7M depicts an exemplary display of positive feedback that is received from a participant. This information is gathered from participants, either by CSRs and/or via the participant websites 401 and enables the system implementer. CSRs and fulfillment providers to measure feedback on the programs offered by the system 100, the fulfillment providers and the fulfillment providers offering the rewards and affinity programs.

FIG. 7N depicts an exemplary display of all documents relating to a selected participant to enable a CSR to gain efficient access to these documents while a participant is on the phone.

FIG. 7O depicts an exemplary display of an interface that may be used to record and/or view operator (CSR) issues, which may be reported automatically to the system administrator, the fulfillment providers, or other entities.

FIGS. 8A-8D provide exemplary graphic user interfaces generated by the CCSS administrative application 405 for display on administrative module 105. FIG. 8A provides an exemplary display of a listing of CCSS administrative options, including access to business partners (businesses offering rewards and/or affinity programs to their customers and/or employees), programs, services, vendors, news, e-mail templates, marketing promotions, reports, data feeds (for example, data ETL from third party data sources via integration services application 413), and partner sales feeds (for example, data ETL from fulfillment providers via web services application 414). FIG. 8B provides an exemplary marketing promotions display, which may be accessed from the menu displayed in FIG. 8A. FIG. 8C provides an exemplary vendor (fulfillment provider) administration screen, which may be accessed from the menu displayed in FIG. 8A. FIG. 8D provides an exemplary vendor information editing interface, which may be accessed by selecting a vendor from the list displayed in FIG. 8C.

FIGS. 9A-9C provide exemplary graphic user interfaces generated by the CCSS 103 for reward points programs. In some implementations, the CSR interfaces relating to reward points programs may differ from those displayed for affinity programs. For example, in FIG. 9A, the CSR participant information edit screen is slightly different from the affinity program member information editing edit screen (see FIG. 7D) and may include points program account specifics, such as a member's card or tag number. Members that are businesses may have multiple associated card or tag numbers (as depicted in FIG. 9A).

FIG. 9B provides an exemplary display of participant transactions, including the transaction ID, purchase date, store number, tag number, amount of transaction, and reward points associated with each transaction. This data is automatically fed from the fulfillment provider's system to ASM 101 and enables CSRs to address participant questions concerning the transactions. This information may also be accessed by participants via participant website 401. Detailed information (such as an itemized listing of purchased products) concerning each transaction may be accessed, for example, using an interface such as that depicted in FIG. 9C.

FIGS. 10A-10D provide exemplary illustrations of a participant (member) website that may be accessed by participants using their access devices 102. The member web sites may be customized by business partner and are populated by ASM 101 with current data relating to the participant and the reward points and/or affinity programs. FIG. 10A depicts an exemplary homepage and member login screen. FIG. 10B depicts a welcome screen that may be displayed to a business (client) administrator after secure log-in is completed. This display may include program sales tools available to a business administrator to aid enrollment efforts. FIG. 10C. provides an exemplary display of service partners, offers and discounts that may be available to a participant in a program offered by a selected business (client). As shown in FIG. 10D, the display may include targeted banner adds that are selected based upon a participant's behavior or profile.

FIGS. 11A-11E provide illustrative examples of displays and interfaces that may be generated by the partner portal 415 and displayed on business partner access devices 104. FIG. 11A displays an exemplary business partner login interface. FIG. 11B provides an exemplary display once a partner has been authenticated. Content may be displayed based upon the user groups and client program participation and updated periodically. FIG. 11C depicts an exemplary tools and resources listing for the business partner, providing real-time access to program marketing information, metrics, and electronic leads (see FIG. 7H). FIG. 11D illustrates a display of electronic leads (as generated in FIG. 7G-7H), and FIG. 11E illustrates a monthly report of electronic leads and their status.

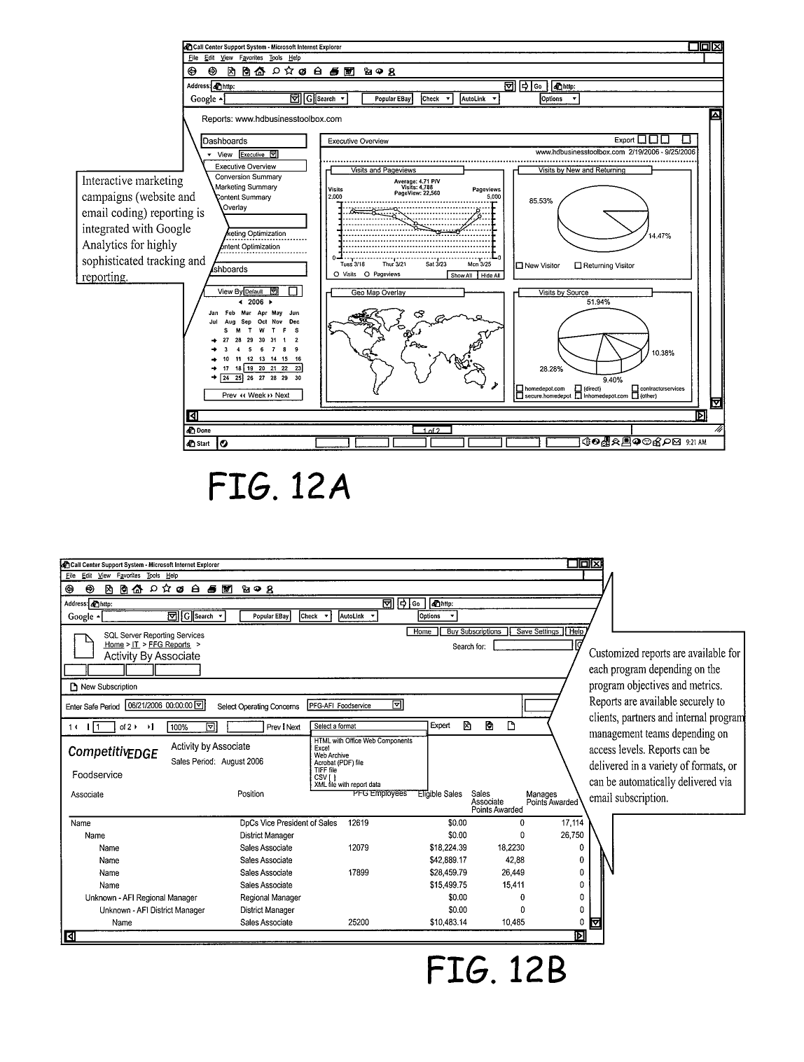

FIGS. 12A and 12B illustrate exemplary reports that may be generated by ASM 101 for access by business partners, system administrators, and other desired recipients via their respective access devices (as shown in FIG. 1). In the report displayed in FIG. 12A, interactive marketing campaigns reporting is integrated with Google® Analytics for sophisticated tracking and reporting. As shown in the example of FIG. 12B, system 100 may generate a variety of customized reports. These customized reports may be made available for each program offered by a business (client) for its member participants. Reports may be made available to a variety of recipients and be provided in a variety of formats. Reports may also be delivered automatically via e-mail subscriptions.

From the above description and drawings, it will be understood by those of ordinary skill in the art that the particular embodiments shown and described are for purposes of illustration only and are not intended to limit the scope of the present invention. Those of ordinary skill in the art will recognize that the present invention may be embodied in other specific forms without departing from its spirit or essential characteristics. References to details of particular embodiments are not intended to limit the scope of the invention.

What is claimed is:

1. A computer-implemented system for administering affinity and reward points programs, comprising:
an administrative module for managing and storing program data associated with a plurality of affinity programs and reward points programs, wherein each affinity program and reward points program is offered by a client to one or more participants, wherein each participant is a customer or employee of the client, and wherein the affinity program or reward points program offered by each client is customizable for the respective client;
at least one participant access device for enabling participant access to program data for each affinity program and reward points program available to the participant, wherein the participant access device obtains and displays program data relating to the available programs from the administrative module and enables the participant to enter data relating to the available programs for transmission to the administrative module;
at least one fulfillment provider access device for enabling fulfillment provider access to program data for selected affinity programs or reward points programs associated with the accessing fulfillment provider, wherein each fulfillment provider provides services, rewards, or other benefits to enable fulfillment of one or more of the associated programs, wherein the fulfillment provider access device obtains and displays program data relating to the associated programs from the administrative module and enables the fulfillment provider to enter data relating to the associated programs for transmission to the administrative module; and
a customer support terminal communicatively coupled to the administrative module for enabling a customer service representative to access and manage participant data, program data, and fulfillment provider data in response to a customer service request from a client, participant or fulfillment provider.

2. The system according to claim 1, further comprising an administrative terminal for enabling a system administrator to perform administrative functions associated with the system.

3. The system according to claim 1, further comprising at least one third party data source, wherein data from the third party source is transmitted from the third party source to the administrative module for use in managing the affinity and reward points programs.

4. The system according to claim 1, wherein the fulfillment provider access device enables a fulfillment provider to access reports on the fulfillment provider's associated programs, wherein the reports are generated by the administrative module.

5. The system according to claim 1, wherein the customer support terminal generates an electronic lead message in response to information obtained by the customer service representative from a participant relating to a selected product or service offered by a selected fulfillment provider, and wherein the electronic lead message is automatically provided to the selected fulfillment provider via the fulfillment provider access device.

6. The system according to claim 1, wherein availability of affinity programs and reward points programs to a selected participant is determined by the one or more clients with whom participant is associated.

7. A computer-implemented method for administering affinity and reward points programs, comprising:
managing and storing program data associated with a plurality of affinity programs and reward points programs, wherein each affinity program and reward points program is offered by a client to one or more participants, wherein each participant is a customer or employee of the client, and wherein the affinity program or reward points program offered by each client is customizable for the respective client;
enabling participant access to program data for each affinity program and reward points program available to the participant, wherein the participant accesses program data relating to the available programs and enters data relating to the available programs;
enabling fulfillment provider access to program data for selected affinity programs or reward points programs associated with the accessing fulfillment provider, wherein each fulfillment provider provides services, rewards, or other benefits to enable fulfillment of one or more of the associated programs, wherein the fulfillment provider accesses program data relating to the associated programs from the administrative module and enters data relating to the associated programs; and
enabling a customer service representative to access and manage participant data, program data, and fulfillment provider data in response to a customer service request from a client, participant or fulfillment provider.

8. The method according to claim 7, further comprising enabling a system administrator to perform administrative functions associated with the system.

9. The method according to claim 7, further comprising receiving third party data from a third party data source, wherein the third party data is used in managing the affinity and reward points programs.

10. The method according to claim 7, further comprising enabling a fulfillment provider to access reports on the fulfillment provider's associated programs.

11. The method according to claim 7, further comprising generating an electronic lead message in response to information obtained by the customer service representative from a participant relating to a selected product or service offered by a selected fulfillment provider, and wherein the electronic lead message is automatically provided to the selected fulfillment provider.

12. The method according to claim 7, wherein availability of affinity programs and reward points programs to a selected participant is determined by the one or more clients with whom participant is associated.
